(19) United States
(12) Patent Application Publication
(10) Pub. No.: US 2007/0124996 A1
(43) Pub. Date: Jun. 7, 2007

(54) Plant flat handle

(76) Inventor: Walter J. Hall, Canton, OH (US)

Correspondence Address: HAHN LOESER & PARKS, LLP, One GOJO Plaza, Suite 300, AKRON, OH, 44311-1076, US

(21) Appl. No.: 11/548,888

(22) Filed: Oct. 12, 2006

Related U.S. Application Data
(60) Provisional application No. 60/725,851, filed on Oct. 12, 2005.

(51) Int. Cl. A01G 9/02

(52) U.S. Cl. 47/65.5

(57) ABSTRACT

A detachable handle for lifting and carrying a plant flat. The handle includes a central carrying portion and a securing portion located at each end of the handle. In construction, each securing portion is divided longitudinally into two subsections, which are separated from each other and capable of being releasably connected to slotted apertures that are found on the top portion of the plant flat.

This application claims priority to provisional application Ser. No. 60/725,851, filed Oct. 12, 2005, the disclosure of which is hereby incorporated by reference.

### BACKGROUND

Today, modern greenhouses, whether raising plants and flowers for the wholesale market, retail market or both, use a large number of plastic carrying trays, usually referred to in the trade as flats. The young growing plants are first started from seeds or vegetative cuttings and after a period of growth, the seedlings or cuttings are transplanted into flats. Customers, both wholesale and retail, can then purchase flats of these flowers or plants. The flat typically has a perforated bottom to allow watering of the plants and an extending lip around the sides and ends of the substantially rectangular flat in order to allow gripping of the container for lifting and carrying the container. Although this construction allows easy nesting of the flats when they are empty, such a structure is awkward to carry. The awkwardness of the flat when loaded makes it susceptible to being dropped. In addition, only one flat can be carried at one time, since the construction necessitates the use of both hands when lifting and carrying of the flat.

In order to overcome the inconvenience of carrying these flats by hand, a detachable handle has been developed which when inserted into slots created in the top portion of the flat, allows a person to carry the flat. These handles are typically made of a strip of plastic having lip portions at each end of the plastic strip. To create the handle, each lip portion of the plastic strip is inserted into a slot of the flat and then rotated in order to retain the plastic strip within the flat. One disadvantage of these lip portions of the plastic strip is that they have a tendency to come loose and disengage from the flat making them inconvenient and visually unappealing to consumers.

It would be desirable to provide a detachable handle for lifting and carrying a plant flat that would be securely retained within the flat during storage and while in use when a person is carrying the flat from one location to another.

### SUMMARY

A first embodiment of the present invention provides a plant container handle comprising: a container-attaching end having a first deformable section, a second deformable section, and an elongated partition substantially separating the first section from the second section, each section having a proximal portion, a distal portion, and a container-securing groove located between the portions.

A second embodiment of the present invention provides a handled plant container comprising: a plant container having a handle-receiving aperture, the aperture having a perimeter; a handle comprising a container-attaching end having a first deformable section, a second deformable section, and an elongated partition substantially separating the first section from the second section, each section having a proximal portion, a distal portion, and a container-securing groove located between the portions, wherein a portion of the handle end is located within the aperture such that a first portion of the aperture perimeter is within the container-securing groove of the first deformable section and a second portion of the aperture perimeter is within the container-securing groove of the second deformable section.

A third embodiment of the present invention provides a method of attaching a handle to a plant container comprising the steps of: providing a plant container having a handle-receiving aperture, the aperture having a perimeter; providing a handle comprising a container-attaching end having a first deformable section, a second deformable section, and an elongated partition substantially separating the first section from the second section, each section having a proximal portion, a distal portion, and a container-securing groove located between the portions, deforming the deformable sections; inserting the handle end into the aperture so that each of the retention grooves is substantially adjacent a separate portion of the aperture perimeter; and, releasing the movable sections so that a first portion of the aperture perimeter is within the retention groove of the first movable section and a second portion of the aperture perimeter is within the retention groove of the second movable section.

### BRIEF DESCRIPTION OF THE DRAWINGS

FIG. 1 is a perspective view of a plant flat embodying the present invention;

FIG. 2 is a fragmentary plan view of one embodiment of the handle of the present invention shown in FIG. 1. FIG. 3 is a fragmentary plan view of another embodiment of the handle of the present invention shown in FIG. 1.

FIG. 4 is a top view of the plant flat handle of the embodiment shown in FIG. 2.

### DESCRIPTION OF THE INVENTION

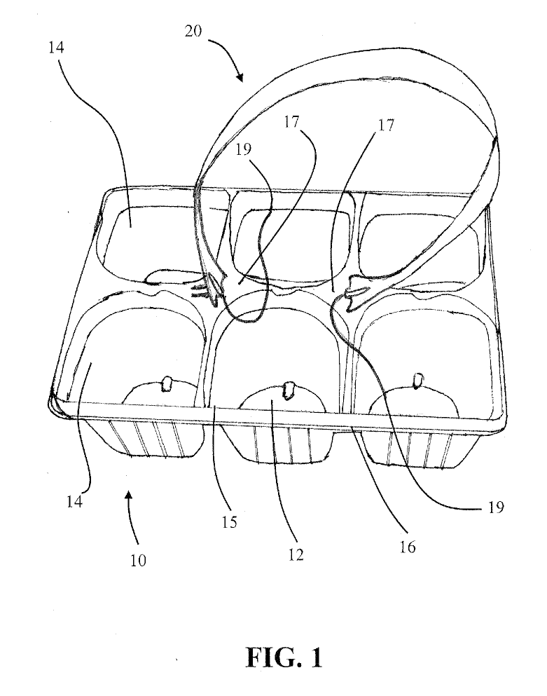

The present invention is directed towards an improved detachable handle for lifting and carrying any container, including, but not limited to, boxes, bags, plant flats, and plant pots. Referring to FIG. 1, an embodiment of the present invention includes a plant flat 10 and a lifting and carrying handle 20, embodying the invention, are shown. The carrying handle 20 is insertably attached to the plant flat 10.

As seen in FIG. 1, the plant flat 10 is shown constructed for holding plants and other vegetation for the wholesale and retail markets. The plant flat includes an array of individual plant compartments 12 arranged in a side-by-side relationship to each other for holding plants and growth media such as dirt. Each plant compartment 12 has a pair of opposite facing sidewalls 14. Each outer edge 15 of sidewall 14 has a continuous outwardly extending lip 16. Each compartment 12 is separated by a central portion 17 that traverses the center portion of plant flat 10. A plurality of apertures 18 and 19 are located within central portion 17, such that handle 20 can be insertably attached to the plant flat 10. The flat 10 is generally of shallow proportions forming an open-top container with each plant compartment having an opening in the bottom portion for moisture drainage. In this open-top container, flowers and plants are easily transplanted for shipment, display and ultimate sale.

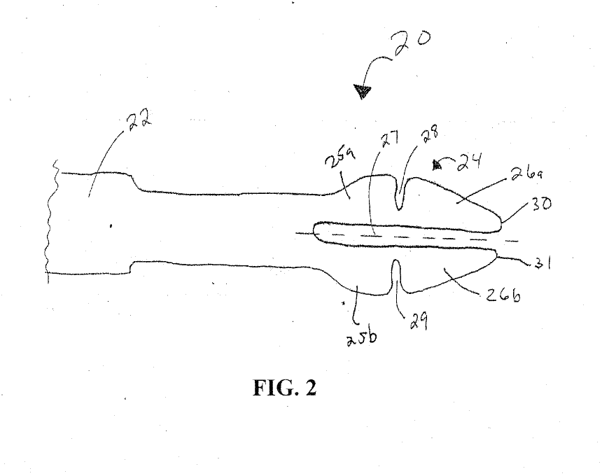

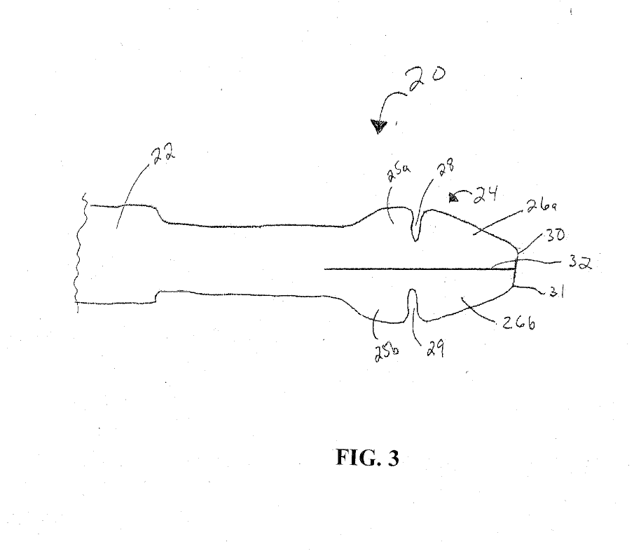

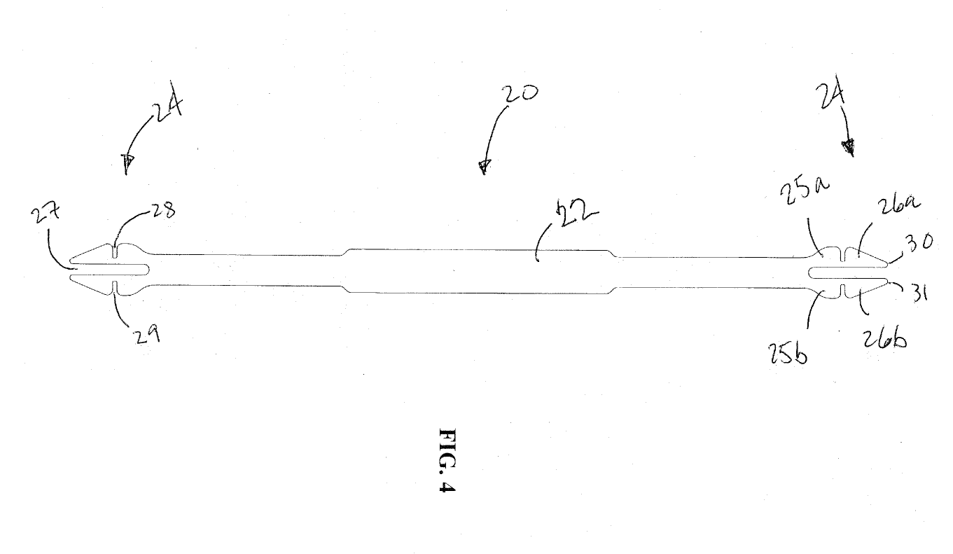

As seen in FIG. 1, a detachable lifting and carrying handle 20 is shown in an attached position to plant flat 10. FIGS. 2 through 4 illustrate the carrying handle 20 of the present invention. Carrying handle 20 may be made out of, at least in part, a suitable thermoplastic material, such as, for example, nylon sheeting, polypropylene, polyethylene or any other single or multilayer flexible material, or any plastic combination. It is contemplated that other suitable plastics (non-thermoplastics) may be used. Handle 20 includes a central carrying portion 22 and a securing end 24 located at each end of handle 20. In the present embodiment, the carrying portion 22 is a strap-like portion; however, it is contemplated that the carrying portion 22 may be ergonomically shaped (such as to provide finger grasping recessions) or may include a shaped opening for inserting one's hand or fingers there through. In construction, each securing end 24 is divided longitudinally into two upper winged sections (or top portions) 25a and 25b along with two lower subsections (or bottom portions), 26a and 26b. In one embodiment, winged sections 25a and 25b, as well as, lower subsections 26a and 26b, are shown as mirror images of each other. However, it is contemplated that in alternate embodiments the winged sections 25a, 25b, and lower subsections 26a, 26b can each be uniquely shaped, or partly mirrored and partly non-mirrored, or any variation thereof. In one embodiment, upper winged sections 25a and 25b along with two lower subsections, 26a and 26b are separated by an elongated slot 27. Each subsection, 26a and 26b, is provided with grooves 28 and 29 that are substantially perpendicular to, but do not come in contact with, elongated slot 27. Securing grooves 28 and 29 can be varied in dimension in relationship to slot 27 in order to accommodate variable-sized apertures in different flats. It is contemplated that only one securing groove may exist (providing an asymmetric handle end, which may also not include a section 25 or subsection 26). The terminal portion (or terminus) of each subsection is desirably pointed, as indicated at 30 and 31, for easy entry into and releasably connected to apertures 18 or 19. The cross-section of the handle 20 may vary and be of any shape, including being substantially rectangular, circular, or oval-like.

The length of slot 27 extends substantially beyond winged section 25a and 25b as seen in FIG. 2. The length of slot 27 should be sufficient to permit collapsing, biasing or bending (collectively referred to as “deforming”) of securing end 24 by pressing together winged sections 25a and 25b together prior to insertion into apertures 18 or 19 of plant flat 10, or by simply forcing the terminal end of the securing end 24 into an aperture and allowing the aperture to force together or otherwise contort the sections 25a and 25b so that the effective cross-section of the securing end 24 is reduced, thereby allowing the securing end 24 to enter and return to a larger cross-section that secures the handle 20 to the aperture via securing grooves 28 and 29. Deforming provides a handle end 24 with a reduced effective cross-section so to allow the handle end 24 to enter any aperture up to a securing groove 28, 29.

In another embodiment of the present invention, as seen in FIG. 3, elongated slot 27 is replaced with a central fold line 32 traversing upper winged sections 25a and 25b along with two lower subsections, 26a and 26b. Similar to slot 27, the length of the central fold line would extend substantially beyond winged section 25a and 25b. The length of central fold line 32 should be sufficient to permit collapsing, biasing or bending of securing end 24 by pressing together winged sections 25a and 25b together prior to insertion into apertures 18 or 19 of plant flat 10.

With the arrangement of handle 20, as described above, assembling the handle 20 with the plant flat 10 may be completed easily and rapidly. Thus, an operator, grasping a first securing end 24 in one hand, may bias or bend it about a longitudinal axis, as seen by the dashed line in FIG. 2, by together pressing the winged sections 25a and 25b, such as between a thumb and a finger, and thereby causing the upper surfaces of winged sections 25a and 25b and subsections 26a and 26b to incline or collapse towards each other. Next, substantially biased pointed lower ends 30 and 31 of a first end portion 24 are inserted into aperture 18 or 19 until subsections 26a and 26b are substantially below the surface of central portion 17. Winged sections 25a and 25b may prevent any further movement through aperture 18 or 19. Insertion of substantially biased pointed lower ends 30 and 31 into the aperture 18 or 19 may be completely effected in one movement, whereupon releasing the hand pressure on the winged sections will permit them to return substantially to their normal plane, with securing grooves 28 and 29 releasably secured into apertures 18 or 19 regardless of the position of the handle end. In order to secure a second securing end 24, the above procedure must be repeated with the other end. The biasing or bending of the winged sections 25a and 25b involves no damaging distortion of the securing portions of handle 10.

A plurality of flats 10, as described above, can readily be stacked together for storage, transport and other purposes, thus providing for a substantial saving of space. Handle 20 of the present invention is flexible enough that it simply collapses when the flats are stacked together without becoming detached from flat 10.

Based on the foregoing disclosure, it should now be apparent that the plant flat handle of the present invention will carry out the objects set forth hereinabove. It is, therefore, to be understood that any variations evident fall within the scope of the claimed invention and thus, the selection of specific component elements can be determined without departing from the spirit of the invention herein disclosed and described.

We claim:

1. A plant container handle comprising:
a container-attaching end having a first deformable section, a second deformable section, and an elongated partition substantially separating the first section from the second section, each section having a proximal portion, a distal portion, and a container-securing groove located between the portions.

2. The container handle of claim 1, wherein each section includes a substantially pointed terminus on the distal portion.

3. The container handle of claim 1, wherein a proximal portion side of each container-securing groove extends further than a distal portion side of the container-securing groove.

4. The container handle of claim 1, wherein the elongated partition is an elongated slot.

5. The container handle of claim 1, further comprising a second container-attaching end having a third deformable section, a forth deformable section, and an elongated partition substantially separating the first section from the second section, each section having a proximal portion, a distal portion, and a container-securing groove located between the portions.

6. The container handle of claim 1, wherein the handle is formed of a plastic.

7. The container handle of claim 1, wherein the handle is monolithic.

8. A handled plant container comprising:
a plant container having a handle-receiving aperture, the aperture having a perimeter;
a handle comprising a container-attaching end having a first deformable section, a second deformable section, and an elongated partition substantially separating the first section from the second section, each section having a proximal portion, a distal portion, and a container-securing groove located between the portions,
wherein a portion of the handle end is located within the aperture such that a first portion of the aperture perimeter is within the container-securing groove of the first deformable section and a second portion of the aperture perimeter is within the container-securing groove of the second deformable section.

9. The handled container of claim 8, wherein the elongated partition is an elongated slot.

10. The handled container of claim 8, further comprising a second container-attaching end having a third deformable section, a forth deformable section, and an elongated partition substantially separating the first section from the second section, each section having a proximal portion, a distal portion, and a container-securing groove located between the portions, the second handle end being attached to a second aperture of the container via the container-securing grooves of the deformable sections.

11. The handled container of claim 8, wherein the handle is formed of a plastic.

12. The handled container of claim 8, wherein the handle is monolithic.

13. A method of attaching a handle to a plant container comprising the steps of:
providing a plant container having a handle-receiving aperture, the aperture having a perimeter;
providing a handle comprising a container-attaching end having a first deformable section, a second deformable section, and an elongated partition substantially separating the first section from the second section, each section having a proximal portion, a distal portion, and a container-securing groove located between the portions,
deforming the deformable sections;
inserting the handle end into the aperture so that each of the retention grooves is substantially adjacent a separate portion of the aperture perimeter; and,
releasing the movable sections so that a first portion of the aperture perimeter is within the retention groove of the first movable section and a second portion of the aperture perimeter is within the retention groove of the second movable section.

14. The method of claim 13, wherein the handle further includes a second container-attaching handle end that is secured to the container by repeating steps three through five of claim 13.

15. The method of claim 13, wherein the elongated partition is an elongated slot.

16. The method of claim 13, wherein the step of deforming occurs concurrently with the step of inserting with the aperture deforming the sections.

17. The method of claim 13, wherein the step of deforming provides a collapse of the deforming sections in a direction inward toward the elongated partition.

18. The method of claim 13, wherein the step of inserting includes inserting the handle end into the aperture until the top portion of either or both of the container-securing grooves contacts an independent portion of the container adjacent the aperture perimeter.

19. The method of claim 13, wherein a top portion side of each retention groove extends further than a bottom portion side of the retention groove in a direction substantially perpendicular to the elongated partition.

20. The method of claim 13, wherein the step of collapsing includes pressing on the upper portions of the sections inwardly toward the partition.
